(19) United States
(12) Patent Application Publication
(10) Pub. No.: US 2009/0127050 A1
(43) Pub. Date: May 21, 2009

(54) Normally closed three pass multi-function torque converter

(75) Inventors: Vural Ari, Wooster, OH (US); Adam Uhler, Sterling, OH (US)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 12/291,619

(22) Filed: Nov. 12, 2008

Related U.S. Application Data
(60) Provisional application No. 61/003,366, filed on Nov. 16, 2007.

(51) Int. Cl. F16H 45/02

(52) U.S. Cl. 192/3.29; 192/3.33

(57) ABSTRACT

A multi-function torque converter, including a pump clutch, and a resilient element arranged to close the pump clutch during operation of the torque converter in a torque converter mode. In one embodiment, the resilient element is arranged to close the pump clutch during operation of the torque converter in lock-up mode. In one embodiment, the torque converter includes a torque converter clutch. In one embodiment, the pump clutch and the torque converter clutch are closed during operation of the torque converter in a lock-up mode.

### CROSS-REFERENCE TO RELATED APPLICATIONS

This application claims the benefit under 35 U.S.C. §119(e) of U.S. Provisional Application No. 61/003,366, filed Nov. 16, 2007.

### FIELD OF THE INVENTION

The invention relates to improvements in apparatus for transmitting force between a rotary driving unit (such as the engine of a motor vehicle) and a rotary driven unit (such as the variable-speed transmission in the motor vehicle). In particular, the invention relates to a normally closed three pass multi-function torque converter.

### BACKGROUND OF THE INVENTION

Multi-function torque converters (MFTCs) are known in the art to enable improved fuel economy over traditional torque converters which do not include a pump clutch. The pump clutch in an MFTC improves fuel efficiency by disconnecting, when desired, the pump, thereby eliminating torque transfer by the pump. Commonly-owned U.S. Pat. No. 6,494,303 discloses a normally open three pass multi-function torque converter.

A normally open three pass MFTC includes a pump clutch, a torque converter clutch (TCC) and three channels to supply pressurized fluid into three corresponding pressure chambers of the torque converter. A MFTC operates in three modes: torque converter mode, lock-up mode, and idle disconnect mode. The pump clutch and the TCC are normally open, or not engaged, when the three channels are supplying equally pressured fluids. In idle disconnect mode, the pump clutch and the TCC are both open. Therefore, the pump (and consequently the turbine) are not transferring torque and do no present an inertial load on the engine. For a vehicle with a normally open three pass MFTC, the pump clutch and the TCC are open when the vehicle is turned off.

In torque converter mode (TC mode), the pump clutch is closed and the TCC is open. To close or engage the pump clutch, and therefore to begin transferring torque from the engine to the pump, one or more channels must supply a higher pressure fluid into the torque converter. In torque converter mode, torque is transferred from the engine (via a cover for the MFTC) to the pump via the pump clutch. The pump and turbine multiply the engine torque and the turbine transmits the multiplied torque to a turbine hub. Thus, in order for a vehicle including a normally open three pass MFTC to start up, and subsequently accelerate, a higher pressure fluid is first needed to close the pump clutch.

In lock-up mode, the pump clutch and the TCC are closed. In lock-up mode, engine torque is directly transmitted from the cover for the MFTC to the turbine hub via the TCC.

At start up not all vehicles can supply fluid sufficiently pressurized to engage the pump clutch, and therefore operate the torque converter in TC mode. If a torque converter included in a vehicle cannot enter TC mode, acceleration is not possible, as no torque is being transferred.

Thus, there is a long-felt need for a torque converter which provides the fuel efficiency benefits of a multi-function torque converter and facilitates operation of an pump clutch during vehicle start-up.

### BRIEF SUMMARY OF THE INVENTION

The present invention broadly comprises a multi-function torque converter, including a pump clutch, and a resilient element arranged to close the pump clutch during operation of the torque converter in torque converter mode. In one embodiment, the resilient element is arranged to close the pump clutch during operation of the torque converter in lock-up mode. In one embodiment, the torque converter includes a torque converter clutch. In one embodiment, the pump clutch and the torque converter clutch are closed during operation of the torque converter in lock-up mode.

In one embodiment, the torque converter includes an axially displaceable piston plate connected to the resilient element, and first and second fluid chambers disposed on opposite sides of the plate. During operation in torque converter mode, respective fluid pressures in the first and second fluid chambers are substantially equal. In one embodiment, during operation in idle disconnect mode, fluid pressure in the first fluid chamber is higher than fluid pressure in the second fluid chamber. In one embodiment, during operation in torque converter clutch lock-up mode, fluid pressure in the first fluid chamber is lower than fluid pressure in the second fluid chamber. In one embodiment, the multi-function torque converter includes an axially displaceable piston plate connected to the resilient element, a damper rotationally connected to a cover for the torque converter and to the pump clutch, and a pump rotationally connected to the pump clutch and the resilient element.

The present invention also broadly comprises a multi-function torque converter, including: a pump clutch with an axially displaceable plate, the clutch closeable by applying force to the plate in a first axial direction; an axially displaceable resilient element engageable with the plate and preloaded to apply a first force in the first axial direction; and a piston plate connected to the resilient element and forming at least a portion of a first chamber. The resilient element displaces the plate in the first axial direction when the first force is greater than a second force exerted by fluid in the first chamber on the piston plate in a second axial direction, substantially opposite the first axial direction.

In one embodiment, the torque converter includes a pump shell. A first end of the resilient element is axially fixed by the pump shell and the piston plate is connected proximate a second end for the resilient element. In one embodiment, the resilient element is pivotable about the first end in response to fluid pressure in the first chamber. In one embodiment, the resilient element is preloaded by contact with the pump shell. In one embodiment, the torque converter includes a torque converter clutch and the piston plate is displaceable to operate the torque converter clutch.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2 is a partial cross-sectional view of a present invention normally closed three pass multi-function torque converter operating in torque converter mode;

FIG. 3 is a partial cross-sectional view of the torque converter shown in FIG. 2 operating in idle disconnect mode;

FIG. 3a is a detail of area 3a shown in FIG. 3;

FIG. 4 is a partial cross-sectional view of the torque converter shown in FIG. 2 operating in lock-up mode;

FIG. 4a is a detail of area 4a shown in FIG. 4;

FIG. 5 is a partial cross-sectional view of the torque converter shown in FIG. 2 showing locations of acting forces and useful distances for calculating the force required by a spring to engage the pump clutch; and,

FIG. 6 is an enlarged view of area 6 shown in FIG. 5.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

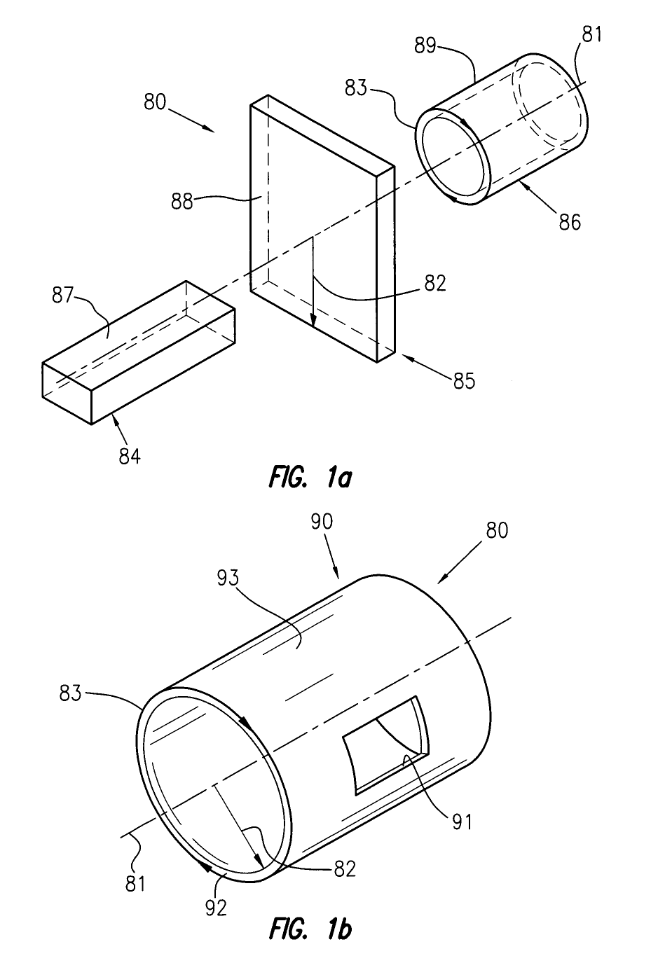

Referring now to the drawings, FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is part of a circumferential plane.

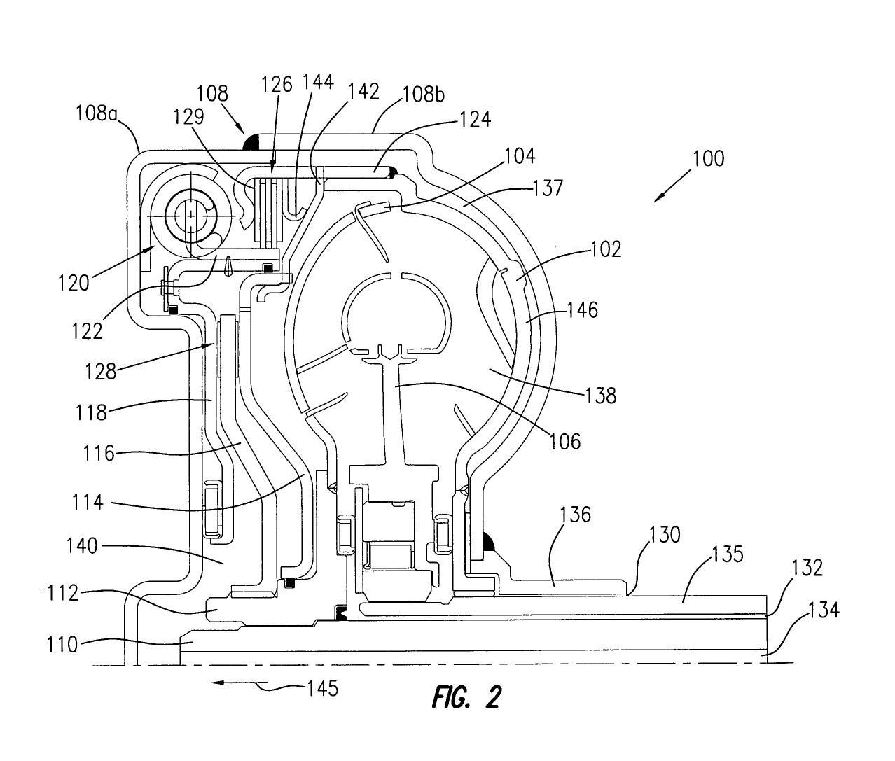

FIG. 2 is a partial cross-sectional view of present invention normally closed three pass multi-function torque converter 100. Torque converter 100 includes pump 102, turbine 104, and stator 106 housed within cover 108, which includes covers 108a and 108b. When torque converter 100 is installed in a vehicle (not shown), cover 108a faces the vehicle's engine (not shown) and cover 108b faces the vehicle's transmission (not shown). Also housed within the cover is input shaft 110 for the transmission, turbine hub 112, piston plate 114, drive plate 116, and damper plate 118 of damper 120. Damper 120 includes drive ring 122. Ring 122 and pump ring 124 of pump 102 form part of pump clutch 126. Torque converter clutch 128 includes plates 114, 116 and 118. Clutch 126 includes at least one clutch plate 129. In one embodiment, clutch 126 includes a plurality of clutch plates 129 alternatively secured to pump ring 124 and the drive ring 122. In such embodiments for clutch 126 which utilize multiple plates, the clutch may be referred to as a clutch pack or pump clutch pack. Five clutch plates 129, with three connected to the pump ring and two connected to the drive ring are shown in FIG. 2. However, it should be understood that torque converter 100 is not limited to a particular number or configuration of plates 129. Thus, the number of clutch plates is not germane to the invention, but it should be appreciated that increasing the number of clutch plates increases the torque bearing surface area of the clutch, thereby increasing the torque capacity of the clutch.

Channels 130, 132, and 134 supply pressurized fluid into torque converter 100. Channel 130 is located between stator shaft 135 and flange 136, channel 132 is located between shaft 135 and shaft 110, and channel 134 is located within shaft 110. Specifically, channels 130, 132, and 134 supply fluid to pressure chambers 137, 138, and 140, respectively. As described infra, manipulation of the respective hydraulic pressures in chambers 137, 138, and 140 causes clutches 126 and 128 to open and close, which subsequently opens and closes respective torque transmission paths through the clutches. By opening a torque transmission path, we mean breaking or interrupting the path. That is, the path is not able to transmit torque along its full length. Alternately stated, the path is made discontinuous. For example, one end of the torque path may experience a torque, but the torque is not transmitted to the other end. By closing a torque transmission path, we mean making the path continuous so that the path is able to transmit torque along its full length.

In FIG. 2, the torque converter is operating in torque converter mode. In one embodiment, in torque converter mode, respective pressures in chambers 138 and 140 are substantially equal. Torque converter 100 includes resilient element 142 and plate, or fulcrum, 144. Element 142 can be any resilient element known in the art, such as a diaphragm spring. In one embodiment, one end of element 142 is slidingly engaged with ring 124 and plate 114 is rotationally connected proximate the other end of element 142. Element 142 is preloaded in direction 145 by contact with the pump, specifically pump shell, or cover, 146, for example, when pump ring 124 is welded onto the pump. Since the respective pressures in chambers 138 and 140 are substantially equal, the preload on the resilient element causes the resilient element to displace in direction 145, contact the fulcrum, and urge the fulcrum against plates 129 to close clutch 126. Alternately stated, the resilient element displaces the plate in direction 145 when a force exerted by the resilient element in direction 145 is greater than a force exerted by fluid in chamber 140 on piston plate 114 in axial direction 147, substantially opposite axial direction 145.

Advantageously, closing clutch 126 enables the torque converter to operate in torque converter mode with all three chambers 137, 138, and 140 having substantially equal pressures, for example, as is the case when a vehicle which is housing the torque converter is turned off. That is, the torque converter operates in torque converter mode without the necessity to increase fluid pressure in the chambers, addressing one of the problems noted supra. The fulcrum is operatively arranged so that when it receives the force of the spring or resilient element, it engages the pump clutch pack. The fulcrum can be any shape which sufficiently receives the force from the spring and transfers that force to the pump clutch pack. In torque converter mode, torque converter clutch 128 is open. Therefore, the torque path originates in the engine of the vehicle and passes through cover 108, to damper 120, to drive ring 122, to pump clutch 126, to pump ring 124, and finally to pump 102 where the torque is hydraulically transferred to the turbine to drive the turbine hub and shaft 110.

As noted supra, equalized pressure between all three chambers can occur when the engine is shut off. Therefore, when the engine is shut off, spring 142 is forcing clutch 126 into an engaged, or closed, position. Thus, torque converter 100 is a normally closed MFTC. That is, the clutch is closed when the engine is not operating or when no pressurized fluids are being delivered into the torque converter. Advantageously, the normally closed design allows the vehicle to accelerate as soon as the engine is started, without first requiring that pressurized fluid be pumped into one or more of the pressure chambers.

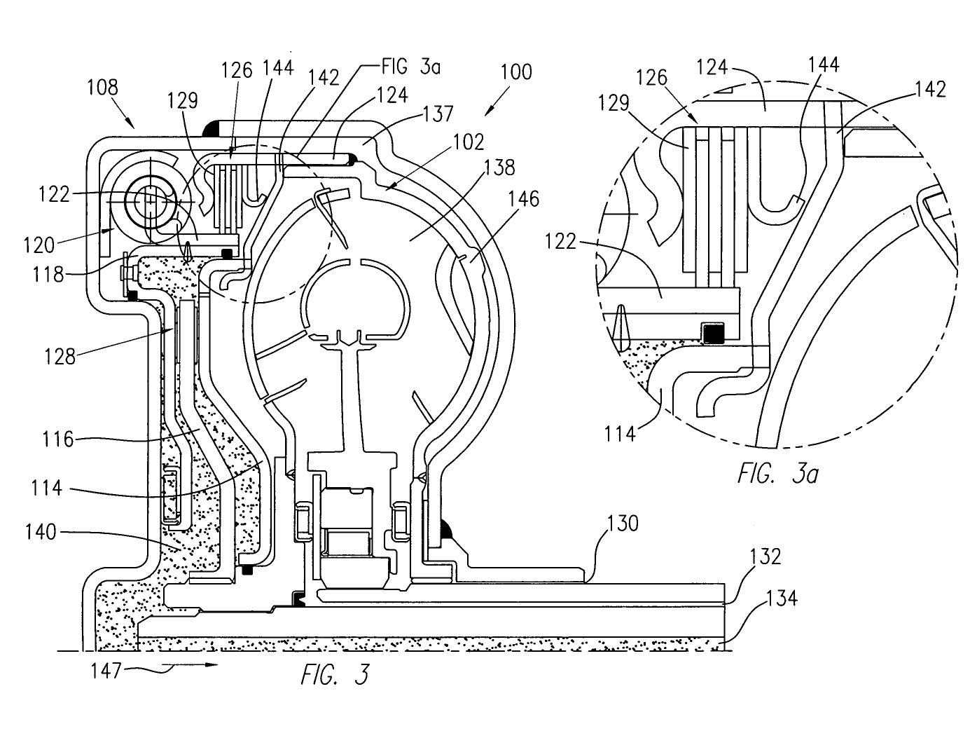

FIG. 3 is a partial cross-sectional view of torque converter 100 shown in FIG. 2 operating in idle disconnect mode.

A close up of the spring, fulcrum, and pump clutch is shown in FIG. 3a. The following should be viewed in light of FIGS. 3 and 3a. In idle disconnect mode clutches 126 and 128 are both open. In idle disconnect mode, pressure chamber 140 is filled with higher pressure fluid via channel 134. The higher pressure area is indicated by the shading which is present throughout pressure chamber 140. The fluid pressure in chamber 140 in higher than the fluid pressure in chamber 138, causing piston plate 114 to axially move in direction 147. The movement of the piston plate pushes spring 142 in direction 147, away from fulcrum 144, thereby releasing pump clutch 126. In FIG. 3a the spring and the fulcrum are not touching, therefore, the clutch is in a released position. When pump clutch 126 is released, the torque path between the engine and the pump is opened, because pump plate 124 is disconnected from drive ring 122. Pressure in chamber 140 displaces plate 114 in direction 147, away from plates 116 and 118, which also opens clutch 128.

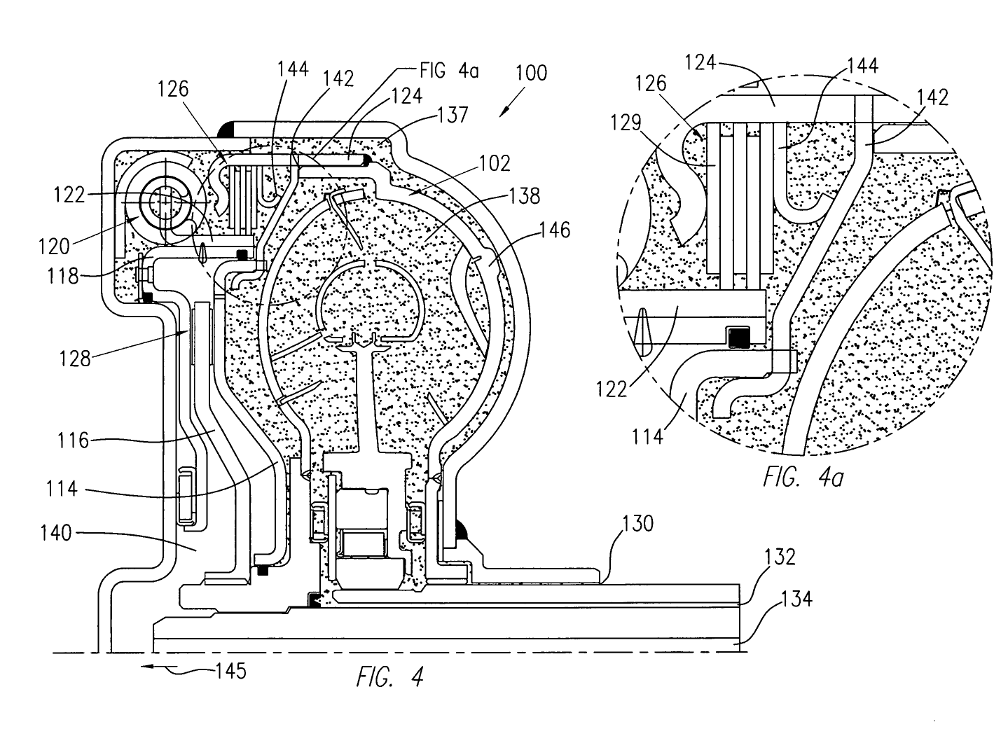

FIG. 4 is a partial cross-sectional view of torque converter 100 shown in FIG. 2 operating in lock-up mode mode.

FIG. 4a is a detail of area 4a in FIG. 4. The following should be viewed in light of FIGS. 4 and 4a. In lock-up mode, clutch 126 and clutch 128 are both closed. In lock-up mode, pressure chambers 137 and 138 are both filled with higher pressure fluid through channels 130 and 132, respectively, as indicated by the shading of those two chambers. The fluid pressure in chamber 138 is higher than the fluid pressure in chamber 140, causing piston plate 114 to axially move in direction 145, opposite to the direction that the piston plate moves in idle disconnect mode. The movement of the piston plate in direction 145 closes clutch 128. Also, the movement of the piston plate urges spring 142 against fulcrum 144 so that pump clutch 126 also closes. Unlike the spring and fulcrum in the idle disconnect mode shown in FIG. 3a, the spring and fulcrum in the TCC lock-up mode are engaged. In lock-up mode the cover of the torque converter is mechanically connected to the turbine hub through the damper and clutch 128 so that torque is transferred directly from the engine through the torque converter clutch to the transmission, thus increasing efficiency.

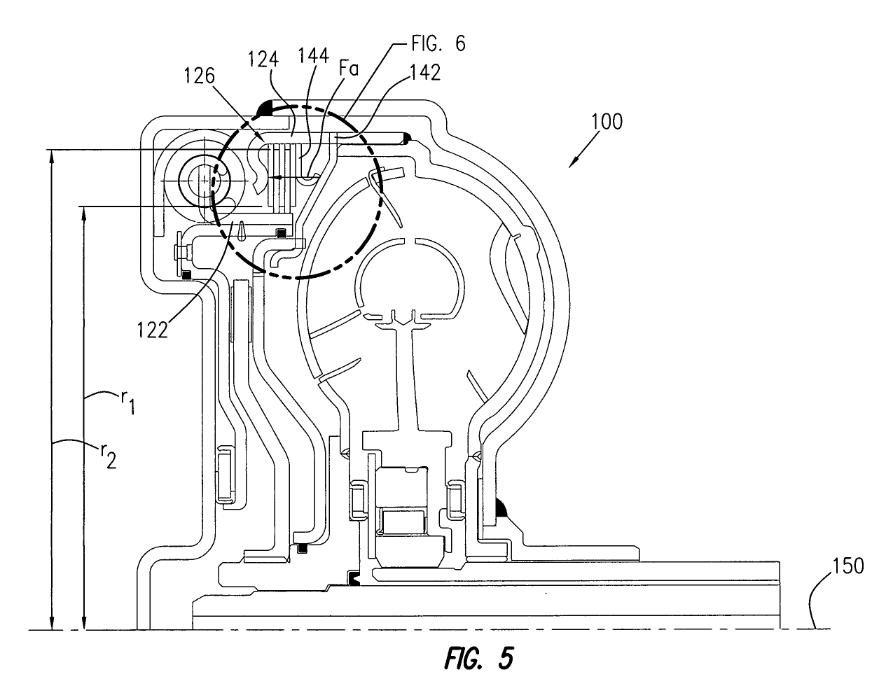

FIG. 5 is a partial cross-sectional view of torque converter 100 shown in FIG. 2 illustrating locations of acting forces and useful distances for calculating the force required by spring 142 to engage the pump clutch. The force of the spring acting on the fulcrum must be high enough to engage clutch 126. The force of the spring acting on the fulcrum, shown in FIG. 5 as apply force Fₐ, can be calculated by the equation T=Fₐ*rₒ*μ*n, where: T is the torque of the engine being transferred to the torque converter; rₒ is the distance from where the force Fₐ is applied and the center of the torque converter, which is represented as dashed line 150, which can be calculated by ⅔*((r₂̂3−r₁\hat{0}3)/(r₂\hat{0}2−r₁\hat{0}2)=rₒ, where r₁ and r₂ are shown in FIG. 5; μ is the coefficient of friction between each set of clutch plates in the pump clutch pack; and n is the number of pairs of surfaces which engage together when the pump clutch pack is closed. For example, if T=500 Nm, r₁=0.115 m, r₂=0.1275 m, μ=0.1, and n=4 (as shown in FIG. 5), then 500 Nm=Fₐ*[⅔*((0.1275̂3−0.115̂3)/(0.1275̂2−0.115̂2)]*0.1*4. Solving for Fₐ, Fₐ=10,330N. It should be appreciated that this is just one sample calculation for one particular set of values which is only included to aid in exemplifying the process of determining the spring loads, and therefore should not in any way limit the current invention. Different torque converters will have different dimensions and specifications, which will clearly result in different values for apply force Fₐ.

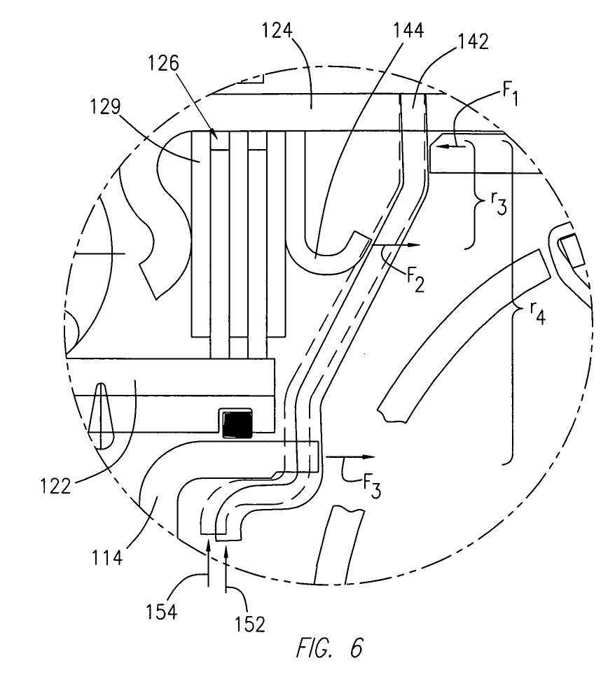

FIG. 6 is an enlarged view of area 6 shown in FIG. 5. Element 142 is shown in two positions: position 152 represented by solid lines, and position 154 represented by dashed lines. The spring is in position 152 when the pump clutch is open, which occurs in idle disconnect mode, as described with respect to FIG. 3. The spring is in position 154 when the pump clutch is closed, which occurs in torque converter and lock-up modes, as described with respect to FIGS. 2 and 4, respectively.

As shown in FIG. 6, force F₃ is the force required through piston plate 114 to shift spring 142 from position 154 to position 152. As discussed supra, the piston plate shifts the spring to position the 152 when there is higher pressure fluid in chamber 140 during operation in idle disconnect mode. Force F₂ is the force required to close the pump clutch. Advantageously, force F₃ is less than force F₂ due to the ratio of distance r₃ to distance r₄. Distances r₃ and r₄ are the respective distances from the forces F₂ and F₃ to the secured end of spring 142. The spring is secured by pump ring 124 and pump shell 146, and force F₁ is the force on the spring applied by shell 146. The distances r₃ and r₄ are substantially measured from the point at which force F₁ is acting. It should be appreciated that force F₂ is equal in magnitude to force Fₐ shown in FIG. 5.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. A multi-function torque converter, comprising:
a pump clutch; and,
a resilient element arranged to close the pump clutch during operation of the torque converter in a torque converter mode.

2. The multi-function torque converter recited in claim 1 wherein the resilient element is arranged to close the pump clutch during operation of the torque converter in a lock-up mode.

3. The multi-function torque converter recited in claim 1 further comprising a torque converter clutch.

4. The multi-function torque converter recited in claim 3 wherein the resilient element is arranged to close the pump clutch during operation of the torque converter in a lock-up mode.

5. The multi-function torque converter recited in claim 1 further comprising:
an axially displaceable piston plate connected to the resilient element; and,
first and second fluid chambers disposed on opposite sides of the piston plate, wherein during the operation in the torque converter mode, respective fluid pressures in the first and second fluid chambers are substantially equal.

6. The multi-function torque converter recited in claim 1 further comprising:
an axially displaceable piston plate connected to the resilient element; and,
first and second fluid chambers disposed on opposite sides of the member, wherein during the operation in an idle disconnect mode, fluid pressure in the first fluid chamber is higher than fluid pressure in the second fluid chamber.

7. The multi-function torque converter recited in claim 1 further comprising:
an axially displaceable piston plate connected to the resilient element; and,
first and second fluid chambers disposed on opposite sides of the member, wherein during the operation in torque converter clutch a lock-up mode, fluid pressure in the first fluid chamber is lower than fluid pressure in the second fluid chamber.

8. The multi-function torque converter recited in claim 1 further comprising:
an axially displaceable piston plate connected to the resilient element;
a damper rotationally connected to a cover for the torque converter and to the pump clutch; and,
a pump rotationally connected to the pump clutch and the resilient element.

9. A multi-function torque converter, comprising:
a pump clutch with an axially displaceable plate, the clutch closeable by applying force to the plate in a first axial direction;
an axially displaceable resilient element engageable with the plate and preloaded to apply a first force in the first axial direction; and,
a piston plate connected to the resilient element and forming at least a portion of a first chamber, wherein the resilient element displaces the plate in the first axial direction when the first force is greater than a second force exerted by fluid in the first chamber on the piston plate in a second axial direction, substantially opposite the first axial direction.

10. The multi-function torque converter recited in claim 9 further comprising a pump shell and wherein a first end of the resilient element is axially fixed by the pump shell and the piston plate is connected proximate a second end of the resilient element.

11. The multi-function torque converter recited in claim 10 wherein the resilient element is pivotable about the first end in response to fluid pressure in the first chamber.

12. The multi-function torque converter recited in claim 10 wherein the resilient element is preloaded by contact with the pump shell.

13. The multi-function torque converter recited in claim 9 further comprising a torque converter clutch and wherein the piston plate is displaceable to operate the torque converter clutch.
